(19) United States
(12) Patent Application Publication
(10) Pub. No.: US 2002/0083129 A1
(43) Pub. Date: Jun. 27, 2002

(54) WWW server on the internet enabling browsing/evaluation of theme-related information and managing user points accompanying proposal, provision, browsing and evaluation of information, and method for operating server

(75) Inventors: Shin Yamade, Tokyo (JP); Masahiro Michiwaki, Tokyo (JP)

Correspondence Address: MARK KUSNER COMPANY LPA, HIGHLAND PLACE SUITE 310, 6151 WILSON MILLS ROAD, HIGHLAND HEIGHTS, OH, 44143

(73) Assignee: Dokonjosoft Co., Ltd. Masahiro Michiwaki

(21) Appl. No.: 10/004,589

(22) Filed: Dec. 4, 2001

(30) Foreign Application Priority Data
Dec. 11, 2000 (JP) 2000-375511

(51) Int. Cl. G06F 15/16

(52) U.S. Cl. 709/203; 709/223

(57) ABSTRACT

A WWW server on the Internet for enabling browsing and/or evaluation of information provided in relation to a proposed theme, while managing users' points accompanying proposal, provision, browsing and/or evaluation of the information, and a method for operating the server. Theme-related information, which was inputted through an information-accepting screen displayed on a user terminal, is recorded (S90). The points of a user who browsed the theme-related information is decreased while the points of a user who proposed the theme is increased, and this is recorded to a database (S60). A user's evaluation in view of the theme-related information is accepted through the user terminal, and the points of a user who provided the theme-related information is increased in accordance with the evaluation result (S80).

### BACKGROUND OF THE INVENTION

The present application claims priority upon Japanese Patent Application No. 2000-375511 filed on Dec. 11, 2000, which is herein incorporated by reference.

1. Field of the Invention

The present invention relates to a WWW server on the Internet which collects information related to a proposed theme, enables users to browse and/or evaluate such information, and conducts users' point management accompanying such proposal and/or browsing, and a method for operating such server.

2. Description of the Related Art

On the Internet, there are many services for information exchange, such as bulletin boards and mailing lists. However, it was difficult for a user, who disclosed information thereon, to obtain evaluation of the information. It was also difficult for a user, who is browsing the information, to determine whether the information is objectively useful. Therefore, there were many cases where users possessing information do not disclose such information to the public, and thus, not too much useful information was exchanged.

### SUMMARY OF THE INVENTION

The present invention has been contrived in order to eliminate the inconveniences of the conventional information-exchange services on the Internet, and an objective of the present invention is to provide a WWW server which can realize a more active information-exchanging service on the Internet, and a method for operating such a server.

Thus, one aspect of the present invention is a WWW server on the Internet enabling browsing and/or evaluation of information provided in relation to a proposed theme, as well as managing users' points accompanying proposal, provision, browsing and/or evaluation of the information. Here, the users accessing the server through respective user terminals are managed by respective user IDs; the each user ID is made to correspond to points which increase/decrease according to such as acceptance/giving of various information through the WWW server; and user information such as the user ID and the points is recorded to an appropriate database. Such a WWW server comprises the following items (1)-(9):

(1) In accordance to an operational input of a user through the user terminal, the server sends, to the user terminal, data for generating an input-accepting screen for inputting a theme for collecting information.

(2) The server accepts the information-collecting theme inputted through the input-accepting screen displayed on the user terminal, and records the theme to an appropriate storage means.

(3) In accordance to an operational input of a user through the user terminal, the server sends, to the user terminal, data for generating a screen for displaying the information-collecting theme and for accepting input of information relating to the theme.

(4) The server records, to the storage means, the theme-related information inputted through the information-accepting screen displayed on the user terminal.

(5) In accordance to an operational input of a user through the user terminal, the server sends, to the user terminal, data for generating a screen for displaying the information-collecting theme and the theme-related information.

(6) The server decreases the points of the user who browsed the theme-related information, and records this to the database.

(7) In accordance to the theme-related information being browsed, the server increases the points of the user who proposed the theme, and records this to the database.

(8) The server accepts the user's evaluation of the theme-related information through the user terminal, and records the evaluation to the storage means.

(9) In accordance to the obtained evaluation result, the server calculates the points of the user who provided the theme-related information, and records this to the database.

Preferably, the evaluation of the theme-related information in the above-mentioned item (8) is a result of a vote accepted from the user terminal.

Further, the server preferably decreases the points of the user who proposed the information-collecting theme, and records this to the database.

Furthermore, the calculation of the points in the above-mentioned item (9) is preferably an addition process.

Further preferably, a billing process to the user is conducted instead of the decreasing of the points.

Another aspect of the present invention is a method for operating a www server connected to user terminals through the Internet in order to enable browsing and/or evaluation of information provided in relation to a proposed theme, as well as manage users' points accompanying proposal, provision, browsing and/or evaluation of the information. Here, the users accessing the server through respective user terminals are managed by respective user IDs; the each user ID is made to correspond to points which increase/decrease according to such as acceptance/giving of various information through the server; and user information such as the user ID and the points is recorded to an appropriate database. Such a method for operating the WWW server comprises the following steps (A)-(I):

(A) a step of sending, in accordance to an operational input of the user through the user terminal, data for generating an input-accepting screen for inputting a theme for collecting information to the user terminal;

(B) a step of accepting the information-collecting theme inputted through the input-accepting screen displayed on the user terminal, and recording the theme to an appropriate storage means;

(C) a step of sending, in accordance to an operational input of a user through the user terminal, data for generating a screen for displaying the information-collecting theme and for accepting input of information relating to the theme to the user terminal;

(D) a step of recording, to the storage means, the theme-related information inputted through the information-accepting screen displayed on the user terminal;

(E) a step of sending, in accordance to an operational input of a user through the user terminal, data for generating a screen for displaying the information-collecting theme and the theme-related information to the user terminal;

(F) a step of decreasing the points of the user who browsed the theme-related information, and recording this to the database;

(G) a step of increasing, in accordance to the theme-related information being browsed, the points of the user who proposed the theme, and recording this to the database;

(H) a step of accepting the user's evaluation of the theme-related information through the user terminal, and recording the evaluation to the storage means; and

(I) a step of calculating, in accordance to the obtained evaluation result, the points of the user who provided the theme-related information, and recording this to the database.

Preferably, the evaluation of the theme-related information in the above-mentioned step (H) is a result of a vote accepted from the user terminal.

Further, it is preferable to decrease the points of the user who proposed the information-collecting theme, and record this to the database.

Furthermore, the calculation of the points in the above-mentioned step (I) is preferably an addition process.

Further preferably, a billing process to the user is conducted instead of the decreasing of the points.

### BRIEF DESCRIPTION OF THE DRAWINGS

For a more complete understanding of the present invention and the advantages thereof, reference is now made to the following description taken in conjunction with the accompanying drawings wherein:

FIG. 1 is a block diagram showing an example of a form of utilizing a WWW server according to one embodiment of the present invention;

FIG. 2 is a flowchart showing an example of an embodiment of an information-providing service according to a method for operating a WWW server of one embodiment of the present invention;

FIG. 3 is a schematic diagram of a top-page screen displayed on a user terminal, among the information-providing service according to the method of operating a WWW server according to one embodiment of the present invention;

FIG. 4 is a schematic diagram of a theme- (subject-) displaying screen displayed on a user terminal, among the information-providing service according to the method of operating a WWW server according to one embodiment of the present invention;

FIG. 5 is a schematic diagram of a theme- (subject-) submission-confirmation screen displayed on a user terminal, among the information-providing service according to the method of operating a WWW server according to one embodiment of the present invention;

FIG. 6 is a schematic diagram of an information-displaying screen displayed on a user terminal, among the information-providing service according to the method of operating a WWW server according to one embodiment of the present invention;

FIG. 7 is a schematic diagram of an information-submission-confirmation screen displayed on a user terminal, among the information-providing service according to the method of operating a WWW server according to one embodiment of the present invention; and

FIG. 8 is a schematic diagram of an evaluation- (vote-) confirmation screen displayed on a user terminal, among the information-providing service according to the method of operating a WWW server according to one embodiment of the present invention.

### DETAILED DESCRIPTION OF PREFERRED EMBODIMENTS

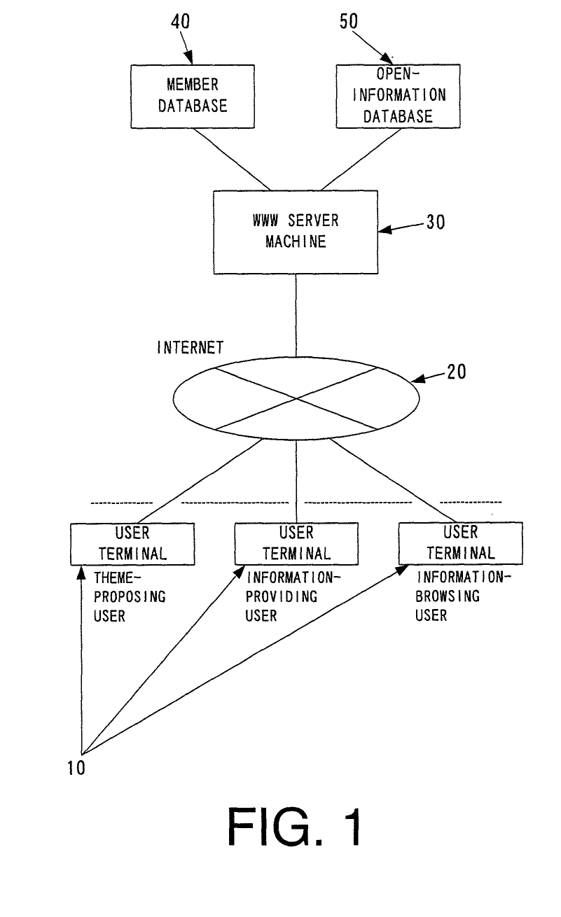

An embodiment of an implementation of the present invention will be described with reference to FIGS. 1-8.

Summary

As is shown in the block diagram of FIG. 1, a user terminal 10 is connected to a WWW (World Wide Web) server machine 30 through a communication network 20 such as the Internet. The server 30 functions as a WWW server that makes a response of necessary information in response to a request from the user terminal 10 of an individual or a company, and also conducts services such as collecting and/or providing information. A homepage on the Internet becomes a place for collecting and/or providing such information. The server 30 is connected to a member database 40. To this member database 40, there are recorded, respectively for each of the users by using respective user IDs, the user's profile such as address, name, and so forth, as well as the points that the user possesses. Further, the server 30 is connected to an open-information database 50. As will be described later on, to this database 50, themes, information relating thereto, and results of evaluation (such as votes) thereof are recorded an stored. It is needless to say that the structure of these databases and the server is only an example, and that appropriate redesigning is possible. For example, all or a part of these databases may be included as a part of a storage of the server.

Further, the users are to play different roles according to the operational action the user makes to the server, and the users are basically divided into the following three types of players (1), (2), and (3).

Each of the users is managed by an appropriate user ID such as name or penname, and the points of each user increases and/or decreases according to whether the user proposes a theme, provides information, and/or browses the theme/information.

(1) Proposer of a theme of which information is to be collected (Theme-proposing user)

(2) Provider (subscriber) of information related to the theme (Theme-related-information-providing user)

(3) Information-browsing (-evaluating) user

It should be noted that, inmost cases, a same user may change roles arbitrarily, that is, for example, a theme-proposing user may become an information-browsing user.

A user, who wishes to use the information-collecting/providing service realized by this system, browses themes which have already been submitted (registered) and of which information is to be collected. Through browsing the themes, the user is able to know what kind of information is submitted (provided), and can select only the information he/she wishes to browse. The themes are submitted with the aim of collecting and/or inquiring information. The user who wishes to browse the information can select and vote for information that he/she browsed among the plurality of information related to a theme, or, can pass a nonconfidence vote indicating that he/she will not vote for either of the information.

In case of introducing a billing system and/or a point system, the user who proposed a theme is billed or requested to pay points as a price for submitting a theme. Further, the user who browsed information is billed or requested to pay points as a price for browsing information. Here, points, according to an amount of remuneration for proposing a theme, are given to the user who proposed (submitted) the theme in which information was browsed. Further, the user, who provided information that was voted for, is given points according to the vote.

These points may be appropriately exchanged into currencies and/or goods, or, it is possible to manage/handle the points themselves as currencies such as Japanese Yen or U.S. dollars. In case the points are handled as currencies in a part of or throughout the whole management, there may be cases in which, particularly, payment of a price for browsing information by the information-browsing user is not done by points, but through billing by such as credit-card settlement.

Specific Operations

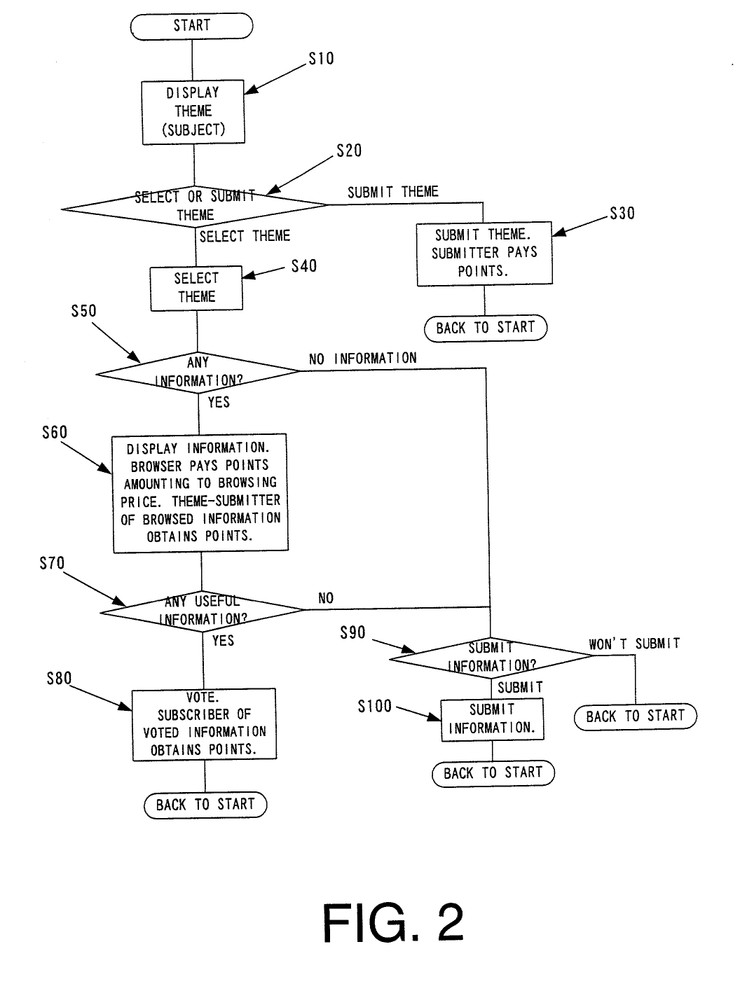

In order to facilitate understanding of how the server of one embodiment according to the present invention works, explanation will be made mainly from the user-terminal side, and with reference to the flowchart of FIG. 2, screens that are displayed to the user terminal and the operational inputs will be exemplified.

Firstly, a user accesses a predetermined WWW server (site) through the Internet using a user terminal such as a personal computer, obtains for example an HTML-format document, and starts browsing.

The series of information/data exchanges between the user terminal and the server that will be explained below is conducted through browsing of HTML documents sent or responded from the server at the user terminal side, and appropriately inputting operational commands at the user terminal side to transmit requests and/or information to the server.

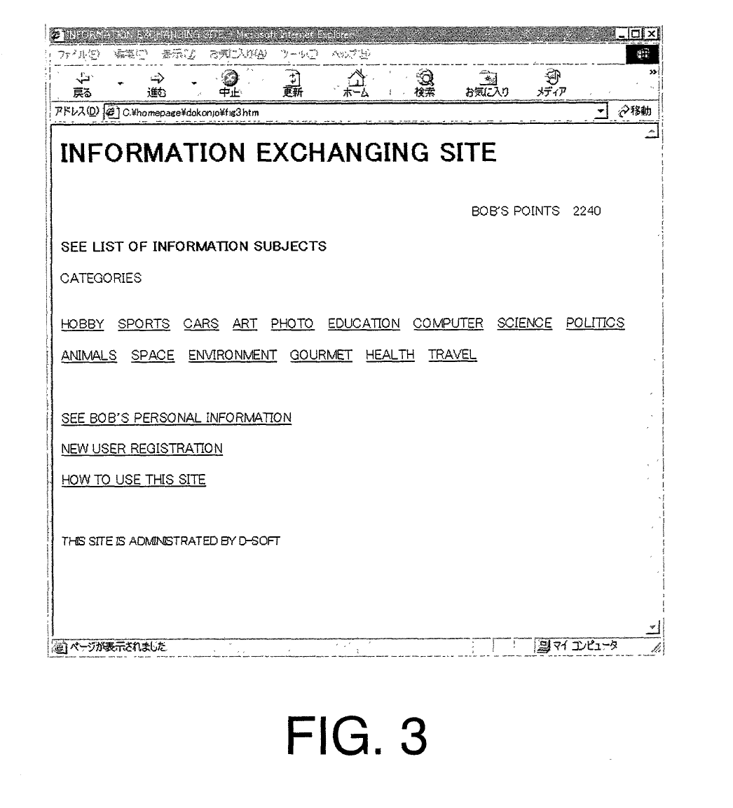

Firstly, as shown in FIG. 3, a homepage (top-page), wherein categories to which the themes belong can be seen in a list, is displayed on the display of the user terminal. In the figure, the “themes” are expressed as “subjects”, for convenience. If the user is already registered as a member, the server refers to the member database, specifies a user ID, and makes the user terminal display the points of the user (“BOB”, in this figure), based on the IP address previously obtained upon server access. (This is indicated on the upper-right of FIG. 3 as “BOB'S POINTS 2240”.) If the user is not registered, by clicking on the title indicating “NEW USER REGISTRATION,” a request to send an HTML document of a new-user-registration screen will be sent to the server.

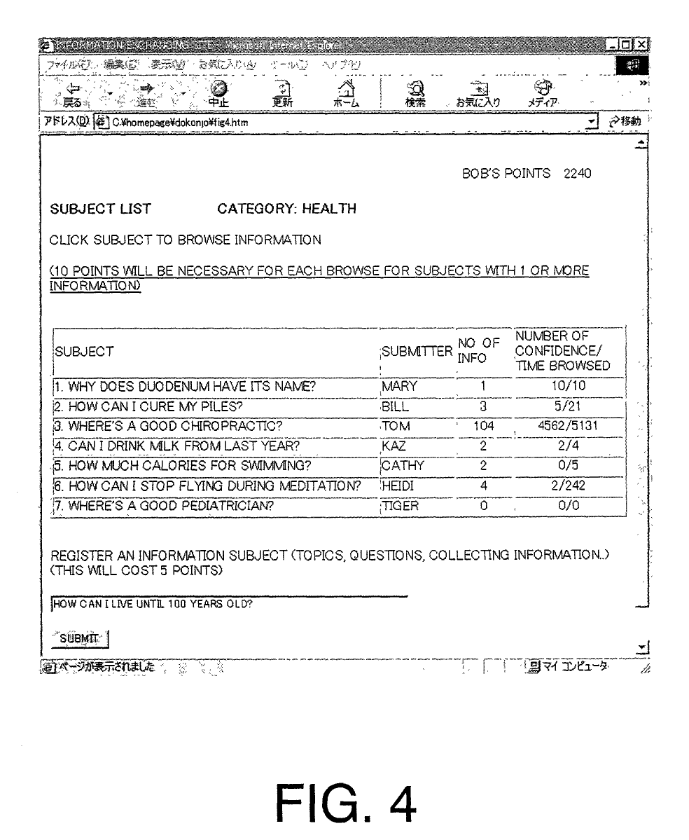

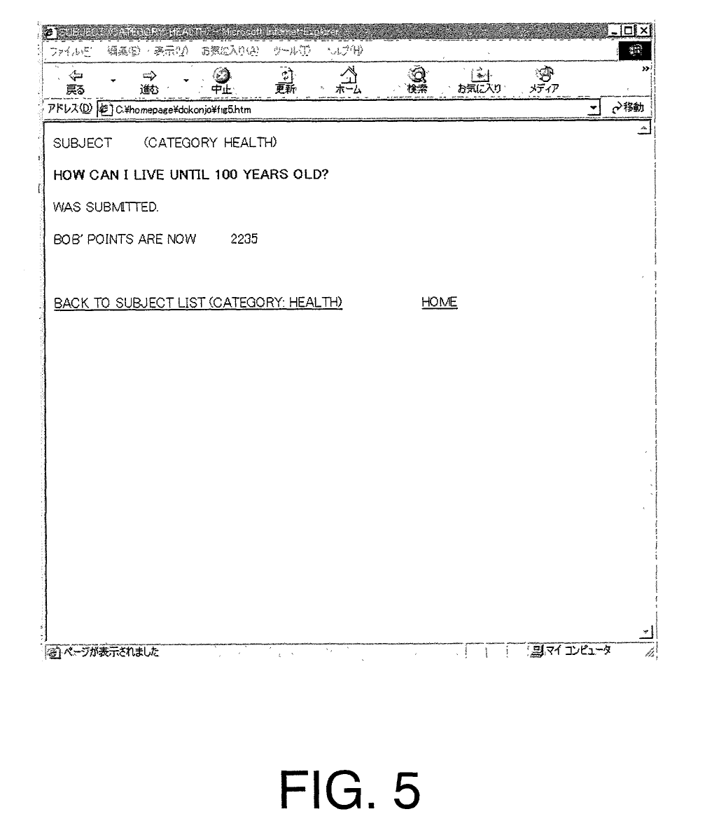

Next, when the user selects a desired category (such as “HEALTH”), as shown in FIG. 4, various submitted themes (subjects) belonging to the “HEALTH” category will be displayed (S10). As is shown in the figure, in this CATEGORY homepage, by clicking on the titles of the displayed themes (subjects) with a mouse, the information relating to the theme is displayed and becomes browsable. In case there exists information in the selected theme, the user is to pay, to the administrator of the present information service, 10 points as a remuneration of browsing information per browsing one theme. Further, in relation to the title of each theme, there are displayed the name of the theme-proposing user (submitter), the number of information provided, the number of times the information was browsed, and the number of confidence as an evaluation of the information. The term “number of confidence” is the number of confidential votes submitted in case a user, who has browsed the information, evaluates that the information is useful, as will be described later on. By referencing the number of information, the number of confidence, and the number of times browsed, the user can estimate whether there exists information in the theme (subject) which is worthwhile of being browsed even by paying the 10 points. Further, the theme-displaying screen shown in FIG. 4 also functions as a screen for inputting a theme for collecting information. On the bottom of FIG. 4, a phrase “REGISTER AN INFORMATION SUBJECT ( . . . )” is displayed, and beneath this phrase, it is displayed “(THIS WILL COST 5 POINTS).” In the figure, a theme “HOW CAN I LIVE UNTIL 100 YEARS OLD?” is inputted by the user (i.e., BOB), and when the “SUBMIT” button therebeneath is clicked, this information-collecting theme will be submitted with payment of 5 points, as is shown in FIG. 5 (S20→S30).

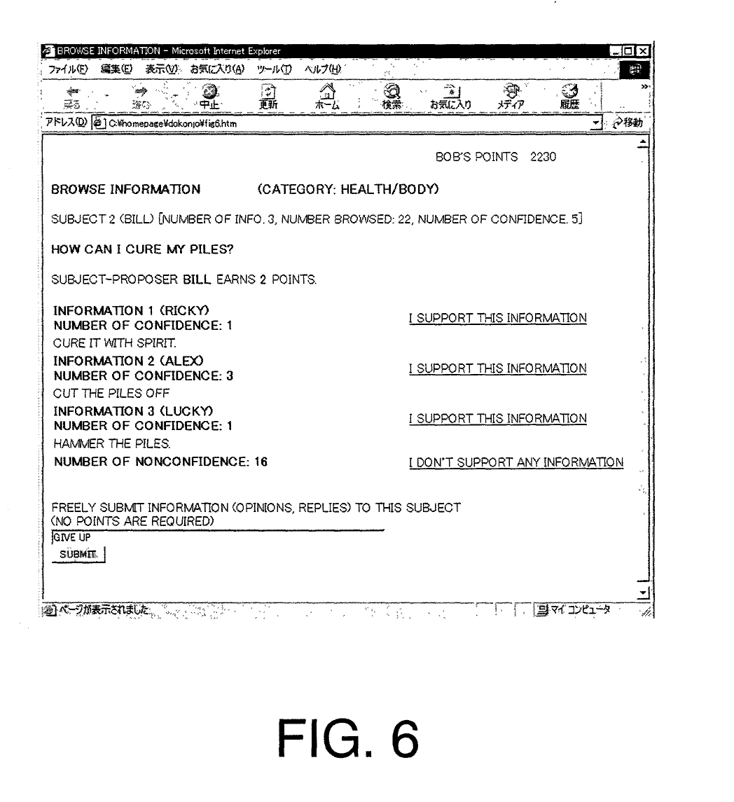

Then, a case will be assumed in which the user appropriately selects a theme from the theme-displaying screen in FIG. 4, and browses information. For example, when the user selects the second-listed theme “2. HOW CAN I CURE MY PILES?” and clicks on the title, an information-displaying screen as shown in FIG. 6 will be displayed, if there exist information under the theme. At this time, the points owned by “BOB” being the information-browsing user will decrease by 10 points (2240−10=2230) for the price of browsing information, whereas 2 points will be given to the user (“BILL”) who proposed the theme that was browsed as a reward (S20→S40→S50→S60).

Note that the timing in which the points are given may be when a result of a vote (evaluation) of confidence or nonconfidence is received, as will be explained later.

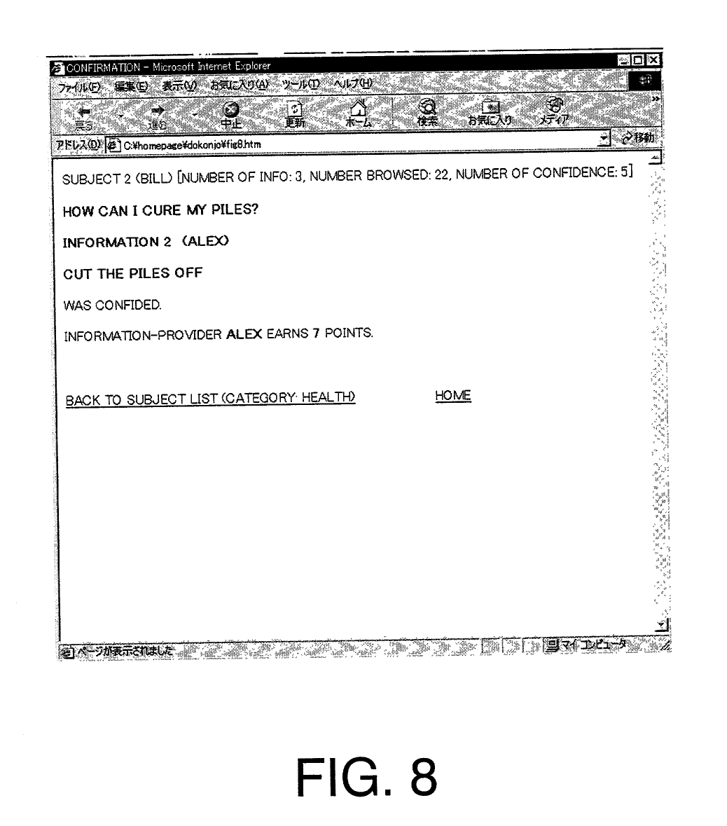

In FIG. 6, there are assigned titles for confidence votes such as “I SUPPORT THIS INFORMATION” on the right side of each of “INFORMATION 1”—“INFORMATION 3”. When a user who browsed information determines that the information is useful and clicks on the corresponding title for confidence vote, the number of confidence of the information will increase by one point (S70→S80). For example, when the user (“BOB”) submits a confidence vote for “INFORMATION 2 (ALEX) CUT THE PILES OFF”, a vote-confirmation screen as shown in FIG. 8 will be displayed, and a message, indicating that 7 points are given to “ALEX” who provided the information as a reward, is displayed.

Note that in FIG. 6, it is possible to submit a nonconfidence vote by clicking on the title “I DON'T SUPPORT ANY INFORMATION” when the user wants to appeal that there was no useful information. In this case, the number of nonconfidence of the theme-related information will increase by one point.

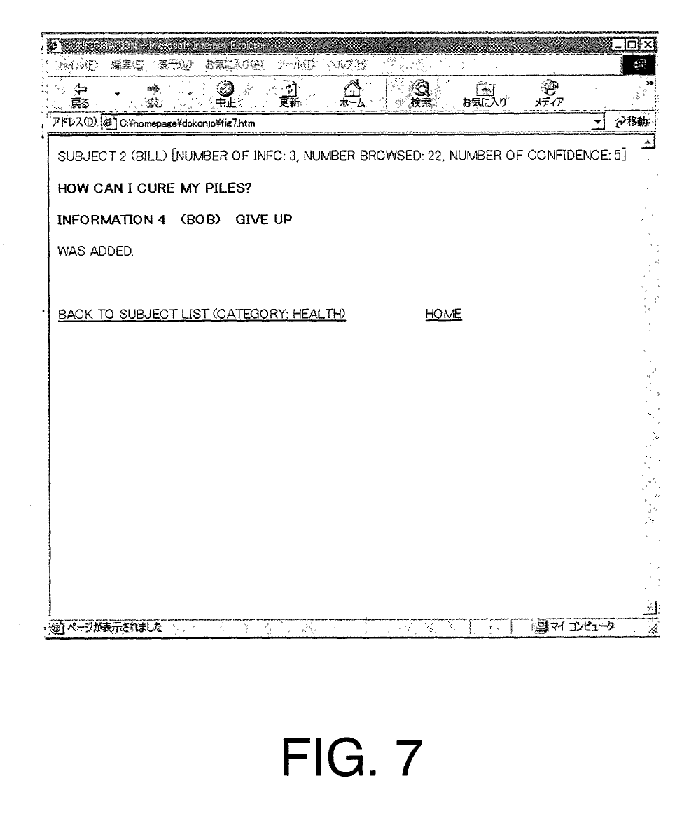

Further, the information-displaying screen shown in FIG. 6 also functions as an input screen for providing (subscribing) information relating to the theme. On the bottom of FIG. 6, there is displayed a phrase “FREELY SUBMIT INFORMATION ( . . . ) TO THIS SUBJECT”, and beneath this phrase, it is displayed “(NO POINTS ARE REQUIRED).” In the figure, there is an opinion inputted by the user (BOB) stating “GIVE UP”, as a kind of information, and when the “SUBMIT” button therebeneath is clicked, this information will be submitted, as is shown in FIG. 7 (S50→S90→S100) and (S70→S90→S100).

OTHER VARIATIONS

The present invention is not limited to the above embodiment, and various redesigning, such as in the mechanism of giving and reducing points, is appropriately possible. Note that the concept of the present invention includes a case where a penalty system, in which the points of an information-providing user is subtracted when a bad evaluation (nonconfidence vote) is submitted in view of the provided information, is additionally provided. Through such a structure, provision of junk information can be effectively prevented.

Further, the concept of the present invention includes a case where points are given to an information-browsing user as a reward for evaluating information, when the information-browsing user submits an evaluation (confidence vote) for the information. Through such a structure, information evaluation by information-browsing users will become more active.

Note that in the present invention, the timing of adding (giving) and/or subtracting (paying) the respective points can be appropriately changed.

Further, the term “user ID” in the present invention has a broad meaning of user-authentication information, and a password, for example, is included in its concept.

The present invention promotes provision of useful information by introducing a point system in which a user who browsed information determines the value of the theme-related information disclosed to the public to let know the objective usefulness of the information, and in which a user who provided (subscribed) the information can obtain remuneration for the information. Particularly, the present invention provides an excellent effect as the following (1) and (2):

(1) The information-providing user can obtain points corresponding to the evaluation. That is, the information-providing (-subscribing) user can only obtain rewards if a good evaluation is earned. Therefore, it is possible to prevent uploading of junk information, and collect as useful theme-related information as possible.

(2) The information-browsing user pays points as remuneration for obtaining the theme-related information. Further, the theme-proposing user obtains points as a reward for providing a good theme (i.e., a place for exchanging information) to where useful information, having the value of being browsed by information-browsing users even by paying points, is collected. That is, the theme-proposing user pays point upon proposing a theme, and obtains points according to the number of times the collected information is browsed. Therefore, the present invention provides a motivation for proposing themes to where needful and useful information is collected.

Further, in the case where a user is to pay points upon proposing a theme, it is possible to prevent proposal of rather unimportant, easy themes, and promote proposal of only useful themes.

Through the mechanism of increasing and decreasing the points of each of the users as payment of rewards and/or remuneration according to the usefulness of the proposed themes and/or the provided theme-related information as described above, it is possible to realize an active service for collecting and/or providing useful information on the Internet, to thereby contribute to public benefit.

Although the preferred embodiment of the present invention has been described in detail, it should be understood that various changes, substitutions and alternations can be made therein without departing from spirit and scope of the inventions as defined by the appended claims.

What is claimed is:

1. A WWW server on the Internet enabling browsing and/or evaluation of information provided in relation to a proposed theme, as well as managing users' points accompanying proposal, provision, browsing and/or evaluation of the information; said users accessing said server through respective user terminals being managed by respective user IDs; said each user ID being made to correspond to points which increase/decrease according to such as acceptance/giving of various information through said WWW server; and user information such as said user ID and said points being recorded to an appropriate database,
wherein said WWW server comprises the following items (1)-(9):
(1) in accordance to an operational input of a user through the user terminal, the server sends, to said user terminal, data for generating an input-accepting screen for inputting a theme for collecting information;
(2) the server accepts said information-collecting theme inputted through said input-accepting screen displayed on said user terminal, and records the theme to an appropriate storage means;
(3) in accordance to an operational input of a user through the user terminal, the server sends, to said user terminal, data for generating a screen for displaying said information-collecting theme and for accepting input of information relating to said theme;
(4) the server records, to said storage means, said theme-related information inputted through said information-accepting screen displayed on said user terminal;
(5) in accordance to an operational input of a user through the user terminal, the server sends, to said user terminal, data for generating a screen for displaying said information-collecting theme and said theme-related information;
(6) the server decreases the points of the user who browsed said theme-related information, and records this to said database;
(7) in accordance to said theme-related information being browsed, the server increases the points of the user who proposed said theme, and records this to said database;
(8) the server accepts the user's evaluation of said theme-related information through said user terminal, and records the evaluation to said storage means; and
(9) in accordance to the obtained evaluation result, the server calculates said points of said user who provided said theme-related information, and records this to said database.

2. A WWW server according to claim 1, wherein said evaluation of said theme-related information in said item (8) is a result of a vote accepted from said user terminal.

3. A WWW server according to claim 1, wherein the server decreases the points of the user who proposed said information-collecting theme, and records this to said database.

4. A WWW server according to claim 1, wherein said calculation of said points in said item (9) is an addition process.

5. A WWW server according to claim 1, wherein a billing process to said user is conducted instead of said decreasing of said points.

6. A method for operating a WWW server connected to user terminals through the Internet in order to enable browsing and/or evaluation of information provided in relation to a proposed theme, as well as manage users' points accompanying proposal, provision, browsing and/or evaluation of the information; said users accessing said server through respective user terminals being managed by respective user IDs; said each user ID being made to correspond to points which increase/decrease according to such as acceptance/giving of various information through said server; and user information such as said user ID and said points being recorded to an appropriate database,
wherein said method for operating said WWW server comprises the following steps (A)-(I):
(A) a step of sending, in accordance to an operational input of the user through the user terminal, data for generating an input-accepting screen for inputting a theme for collecting information to said user terminal;
(B) a step of accepting said information-collecting theme inputted through said input-accepting screen displayed on said user terminal, and recording the theme to an appropriate storage means;
(C) a step of sending, in accordance to an operational input of a user through the user terminal, data for generating a screen for displaying said information-collecting theme and for accepting input of information relating to said theme to said user terminal;
(D) a step of recording, to said storage means, said theme-related information inputted through said information-accepting screen displayed on said user terminal;
(E) a step of sending, in accordance to an operational input of a user through the user terminal, data for generating a screen for displaying said information-collecting theme and said theme-related information to said user terminal;
(F) a step of decreasing the points of the user who browsed said theme-related information, and recording this to said database;
(G) a step of increasing, in accordance to said theme-related information being browsed, the points of the user who proposed said theme, and recording this to said database;
(H) a step of accepting the user's evaluation of said theme-related information through said user terminal, and recording the evaluation to said storage means; and
(I) a step of calculating, in accordance to the obtained evaluation result, said points of said user who provided said theme-related information, and recording this to said database.

7. A method for operating a WWW server according to claim 6, wherein said evaluation of said theme-related information in said step (H) is a result of a vote accepted from said user terminal.

8. A method for operating a WWW server according to claim 6, wherein the points of the user who proposed said information-collecting theme are decreased, and this is recorded to said database.

9. A method for operating a WWW server according to claim 6, wherein said calculation of said points in said step (I) is an addition process.

10. A method for operating a WWW server according to claim 6, wherein a billing process to said user is conducted instead of said decreasing of said points.
